(19) United States
(12) Patent Application Publication
(10) Pub. No.: US 2009/0124315 A1
(43) Pub. Date: May 14, 2009

(54) Ultimate draw poker

(75) Inventors: Roger M. Snow, Las Vegas, NV (US); Daymon B. Savage, Las Vegas, NV (US); Robert P. Scott, Las Vegas, NV (US)

Correspondence Address: Ken Plochinski;Woodcock Washburn LLP, Suite 3600, 999 Third Avenue, Seattle, WA, 98104-4038, US

(73) Assignee: Shuffle Master, Inc.

(21) Appl. No.: 11/983,459

(22) Filed: Nov. 9, 2007

(51) Int. Cl. A63F 13/10; A63F 1/00

(52) U.S. Cl. 463/13; 273/292; 463/25

(57) ABSTRACT

Wagering game methods and apparatus for playing a Draw Poker type live casino and/or electronic game against a dealer and/or a pay table. Players place an ante wager to participate in the game. Each player and the dealer are dealt initial hands. Each player may discard any portion including all of his or her cards. The dealer discards according to predetermined criteria. Discarded cards are replaced by community draw cards in a specified order to complete final hands. Alternatively, each player and the dealer may be dealt their initial hands and replacement cards from their own associated decks. The ante wager is paid if the player's final hand outranks the dealer's final hand. An optional ante wager is paid according to a paytable if the player's final hand achieves at least a minimum bonus qualifying rank.

### FIELD

The disclosure herein relates to games, and more particularly to card-type games suitable for use in a gaming environment, and more particularly to poker-type card games.

### BACKGROUND

Card games have provided a source of popular leisure activities for a great many years. Such games are generally easily accessible and require little in the way of equipment. Often, no more is required than one or more decks of cards, a place to play, and participants. Poker-type games enjoy widespread popularity. Poker-type games generally involve wagering, and many share a widely known ranking of hands.

Poker-type games are offered in casinos and in cardrooms and are enjoyed in countless homes. In a conventional cardroom poker game, the house provides a dealer, the playing cards, the table and chairs, but the house does not play a hand. The house may collect a nominal percentage of each pot (“the rake”) that compensates the house for providing the facilities to the players. Alternatively, the house may charge each player a set amount per hand or a fee for a specified length of time of play. Each player competes not against the house, but against the other players. In many versions, the player with the highest hand wins the total of all the wagers made on that hand minus any rake.

Some players prefer not to compete with other players, but rather prefer to play against the house. For example, some players would rather win money from an impersonal source such as the house or a casino than from individual fellow players. Some players may perceive cardrooms as intimidating, requiring advanced poker skills. A variety of poker-type card games have been introduced that provide house-banked casino table games having elements of standard poker. Successful games of this type generally have rules that are clear and readily learned by new players. They provide relatively quick and exciting play with a high enough win frequency to appeal to players while allowing the house to retain a reasonable profit. Examples of popular table games based on poker include Let It Ride Bonus®, Three Card Poker®, Four Card Poker®, Caribbean Stud®, Crazy 4 Poker®, and Ultimate Texas Hold'em®.

### SUMMARY

A poker game is described that may be played in any setting suitable for providing card game play such as, by way of examples and not of limitation, a live game, an electronically presented game, a combination of live and electronically presented game, or a single player practice game played with the aid of a computing device.

In an embodiment, players make an ante wager to participate in the game. Five cards are dealt to each player and to a dealer. After examining his or her cards, each player may discard up to all five cards. The dealer discards according to a predetermined set of rules. Five community replacement cards are dealt. Final hands are formed for each player and for the dealer by replacing any discards with community replacement cards in a specified order. For example, each participant who discarded one card completes his or her hand by replacing the discarded card with the community replacement card designated as the first; each participant who discarded two cards completes his or her hand by replacing the discarded cards with the community replacement cards designated as the first and second; and so forth. Each player's ante wager is resolved at least in part by comparison of the poker rank of the player's final hand with the poker rank of the dealer's final hand.

In an embodiment, the ante bet is paid at even money if the player's final hand outranks the dealer's final hand and the dealer's final hand qualifies by achieving at least a designated minimum poker ranking. The player is paid at a fraction of even money if the player's final hand outranks the dealer's final hand and the dealer's final hand does not qualify by achieving at least the designated minimum poker ranking. The ante wager is lost when the dealer's final hand outranks the player's final hand.

In an embodiment, an optional bonus wager is provided wherein a player competes against a pay table. The bonus wager is paid according to the poker rank of the player's final hand independent of the outcome of the ante wager.

### BRIEF DESCRIPTION OF THE DRAWINGS

The foregoing summary, as well as the following detailed description, is better understood when read in conjunction with the appended drawings.

FIG. 1 is a flow diagram of an example of a method of playing a game according to the teachings herein;

FIG. 2 is a flow diagram of another example of a method of playing a game according to the teachings herein;

FIG. 3 is a flow diagram of criteria for determining a dealer's discards;

FIG. 4 is a plan view of an apparatus for playing a game according to the teachings herein; and

FIG. 5 is a plan view of a player station.

### DETAILED DESCRIPTION OF ILLUSTRATIVE EMBODIMENTS

The inventive subject matter is described herein with specificity to meet statutory requirements. However, the description itself is not intended to limit the scope of this patent. Rather, the inventor has contemplated that the claimed subject matter might also be embodied in other ways, to comprise different steps or combinations of steps similar to the ones described in this document, and in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

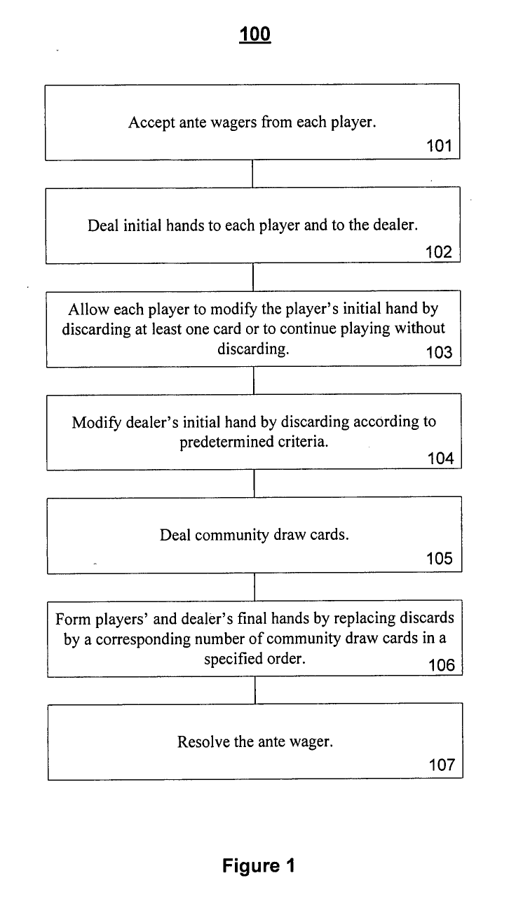

FIG. 1 is a flow diagram of an example method 100 of playing an embodiment of the disclosed game. It should be understood that the method 100 may be presented as a live table game, as an electronically presented game, as a combination of live and electronically presented games, or in any environment adapted to the presentation of a wagering card game. For instance, the game may be adapted for practice play (not involving wagering of currency) on home computers, on internet gaming websites or on cell phones. The “dealer” may be live or may be presented electronically. The “cards” may be physical playing cards, electronic images of playing cards, or any representation of symbols suitable for playing a poker-style game. The wagers may be in the form of actual currency, gaming chips, credit or non-monetary credits.

An ante wager is accepted 101 from each player who enters the game. The wager may for example be monetary or may be non-monetary (i.e. for practice play). Initial hands are then dealt 102 to each player and to the dealer. In a preferred embodiment, the initial hands consist of five cards. Cards are dealt from a shuffled deck. If the game is played with physical playing cards, the cards may be shuffled by hand or may be shuffled by a microprocessor or computer controlled shuffling machine. The shuffling machine may, in addition to randomizing the order of the cards, arrange the cards into single hand sized groups.

In one example of the invention, a standard 52-card deck is used. In other forms of the invention, in particular, video formats, each hand (and/or community cards) may be dealt from a separate deck.

In other embodiments, additional decks or special decks may be used. For example, the game might be dealt from two intermixed decks, enabling additional outcomes such as five-of-a-kind, for example. In other embodiments, special decks (such as a Spanish 21™ deck with all 10 value cards removed) are used possibly resulting in different poker rankings and winning arrangements of cards.

When the game is offered in an electronic format or in a remote wagering format, the number of players can easily exceed the number of available cards. The maximum number of players that can play against the dealer in a five-card version of the game is eight. Each player, plus the dealer, plus the community cards would require a total of 50 cards with two left over.

In instances where a greater number of players were participating, the dealer could receive cards from one deck, while each player receives cards from a separate deck. All community cards dealt could be removed from both the dealer and player decks before the player and dealer hands are dealt. Similarly dealt player cards can be removed from the dealer deck and vice versa. This is a preferred format for video and/or remote wagering versions of the game.

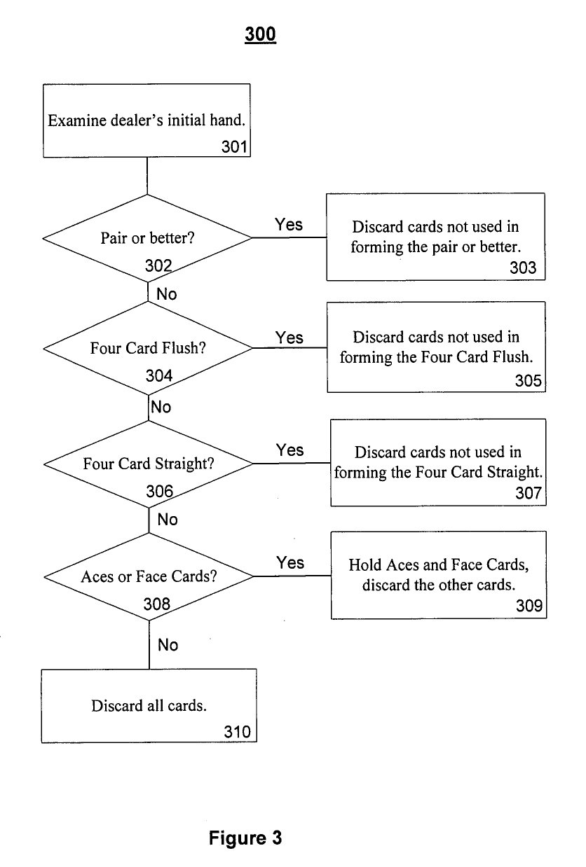

Each player examines his or her cards and is allowed 103 to modify his or her initial hand by discarding at least one card or to continue playing without discarding. In a preferred embodiment, each player may discard as many as all of his or her cards. Preferably, the dealer's hand remains face down while the players examine their cards and determine whether and what to discard. After the player's select their discards, the dealer reveals the dealer's initial hand and modifies 104 the dealer's initial hand by selecting discards according to predetermined criteria. An example of criteria used to determine the dealer's discards is described in detail below with reference to FIG. 3.

A set of community replacement cards is dealt 105. In a preferred embodiment, five community replacement cards are dealt. The community replacement cards may, for example, be dealt face up after the players and dealer determine the cards to be discarded. In another embodiment, the community replacement cards may be dealt face down before the players and dealer determine their discards and then revealed after the discards are determined. The community replacement cards are designated a specific ordering. For example, the community replacement cards may be assigned the order in which they are dealt, with the first community replacement card dealt being designated the first community replacement card, and so forth. The cards may be dealt to specified locations on a playing surface, each location bearing an ordinal designation for the position of the corresponding community replacement card in the specified ordering.

The players and the dealer form their final hands by replacing any discards by a corresponding number of community replacement cards. According to an embodiment replacement cards are used according to a specified order 106. For example, if a player discarded just one card, the player's final hand would consist of the four cards not discarded from the player's initial hand and the community replacement card designated as the first. All players who discarded just one card would have their hands completed by the addition of the same first designated community replacement card. All players who discarded exactly two cards would have their hands completed by the addition of the first and second designated community replacement cards, and so forth. The dealer's hand is similarly completed by replacing any discards by a corresponding number of community replacement cards in the specified order. Although the specified order in this example is from left to right from the player's perspective, other orders are contemplated. For example, a reverse order or player selectable order could be used. The order may be determined before, during or after player cards are revealed to the player.

Upon formation of the players' and dealer's final hands, the ante wager is resolved 107. A player's ante wager is paid if the player's final hand outranks the dealer's final hand. Note that the player's final hand need only outrank the dealer's final hand in order for the player to win the ante wager. In one embodiment, the player wins a larger amount if the dealer hand also qualifies with a minimum ranking or better. The rank of the other players' final hands is not relevant to the outcome of any given player's ante wager. In a preferred embodiment, the well-known standard poker rankings are used to compare hands. Five-card poker hands are ranked from “Royal Flush” (highest) to “High Card(s) in Hand according to the ordering in Table 1. Higher ranking hands beat lower ranking hands. In some variations, an Ace may also act as the lowest denomination when used in a sequence such as A 2 3 4 5. Hands with the same ranking are compared according to established rules.

TABLE 1

| Hand | Description | Example |
|---|---|---|
| Royal Flush | The five top cards in a single suit | A, K, Q, J, 10 (all in one suit) |
| Straight Flush | Five cards in sequence in the | 8, 7, 6, 5, 4 (all in one suit) |
| | same suit | |
| Four of a Kind | Four cards of the same | 8, 8, 8, 8, K |
| | denomination | |
| Full House | Three cards of a first | 9, 9, 9, 5, 5 |
| | denomination and two cards of a | |
| | second denomination | |
| Flush | Five cards (not all in sequence) | K, 9, 7, 6, 3 (all in one suit) |
| | in a single suit | |
| Straight | Five cards in sequence (not all in | 9, 8, 7, 6, 5 (mixed suits) |
| | a single suit) | |
| Three of a Kind | Three cards of the same | 5, 5, 5, K, 9 |
| | denomination and two unpaired | |
| | cards | |
| Two Pair | Two cards of a first | 9, 9, 5, 5, J |
| | denomination, two cards of a | |
| | second denomination, and one | |
| | card of a third denomination | |
| One Pair | Two cards of the same denomination | 8, 8, K, 7, 2 |
| | and three cards of different | |
| | denominations | |
| High Card(s) in | Five cards of distinct | A, J, 9, 8, 5 (mixed suits) |
| Hand | denominations and mixed suits | |

As mentioned above, the rate at which the ante bet is paid when the player's final hand outranks the dealer's final hand may depend on whether the dealer's final hand “qualifies” by achieving at least a predetermined ranking. In a preferred embodiment, a player is paid even money on the ante bet if the player's final hand outranks the dealer's final hand and the dealer's final hand qualifies with a ranking of one pair or higher. The player is paid half of the ante wager if the player's final hand outranks the dealer's final hand and the dealer's final hand fails to qualify, having a ranking below one pair. If the dealer's final hand outranks the player's final hand, the player loses the ante wager.

Other embodiments of the invention incorporate other betting structures. For example, the player may be required to place a play wager before or after discarding unwanted cards or be forced to fold. In yet other embodiments, the player may be given a choice to check, place a play wager or fold. The play wager may be less than, equal to or greater than the ante wager. In some embodiments, the player can select a play wager that is a multiple of the ante wager, such as 2×, 3×, 4× or 5× the ante wager.

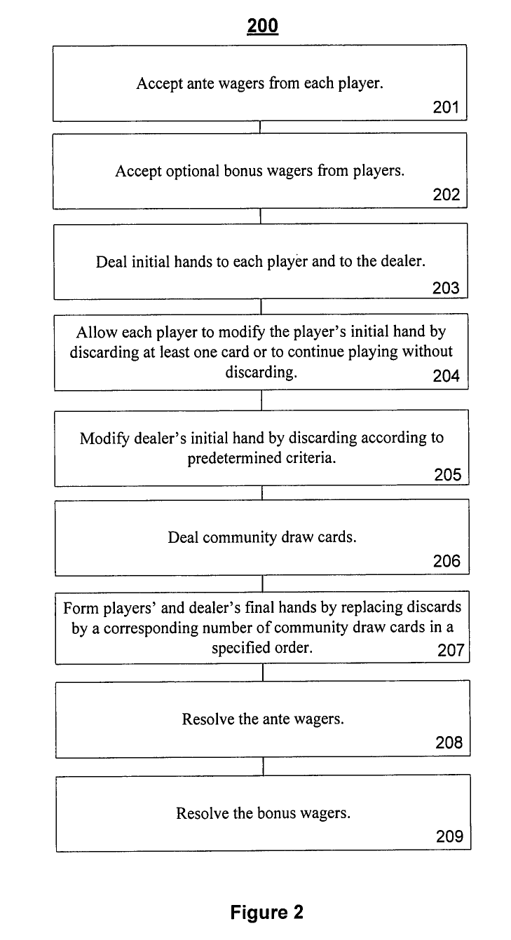

FIG. 2 is a flow diagram of an example of a method 200 of playing an embodiment of the disclosed game including an optional bonus wager. The play of the underlying game is identical to the method 100 of FIG. 1. An ante wager is accepted 201 from each player who enters the game. An optional bonus wager is accepted 202 from those players who choose to make the bonus wager. Initial hands are then dealt 203 to each player and to the dealer. The players are allowed to modify their initial hands by discarding or to continue playing without discarding 204. The dealer reveals the dealer's initial hand and modifies it by discarding, or not, according to predetermined criteria such as, for example, those described in connection with FIG. 3 below. Community draw cards are dealt 206 and final hands for the players and the dealer are formed by replacing any discards with a corresponding number of community draw cards in a specified order 207. The ante wagers are resolved 208 in a manner such as described above in relation to step 107 of FIG. 1.

The optional bonus wagers are resolved 209. If a player's final hand fails to qualify by achieving a predetermined minimum bonus qualifying ranking, the player's bonus wager is lost. If the player's final hand qualifies, the player's bonus wager is paid according to a pay table. In a preferred embodiment, the bonus wager is paid, or not, independent of the outcome of the ante wager. Table 2 provides an example of a pay table for the bonus wager having a minimum bonus qualifying ranking of two pair.

TABLE 2

| Hand | Bonus Payout |
|---|---|
| Royal Flush | 500 to 1 |
| Straight Flush | 100 to 1 |
| Four of a Kind | 25 to 1 |
| Full House | 10 to 1 |
| Flush | 9 to 1 |
| Straight | 8 to 1 |
| Three of a Kind | 3 to 1 |
| Two Pair | 1 to 1 |

The bonus pay table of Table 2 may be modified in a variety of ways and may be adapted to variations in the underlying game. Preferably, the bonus payouts are related to the odds of attaining a final hand having a given poker ranking. In an alternative embodiment, the bonus wager may fixed at a specified amount, such as for example $1.00, and be linked to a progressive jackpot.

Preferably, the ante wager is required for a player to enter the game and the bonus wager is an optional wager. In alternative embodiments, the bonus wager may be mandatory. In other embodiments, a player may be allowed to enter the game by placing a bonus wager without placing an ante wager.

FIG. 3 is a flow diagram for an embodiment of predetermined criteria 300 for use in determining a dealer's discards such as may be used, for example, in connection with step 104 of FIG. 1 or step 205 of FIG. 2. The predetermined criteria ensure that the dealer discards are always made in a consistent manner and will not depend on the skill of a particular dealer. After the initial hands have been dealt and the players have selected their discards, the dealer's initial hand is examined 301. First it is determined whether the dealer's initial hand has a poker ranking of a pair or better 302. If so, the “Yes” path out of 302 is taken and the dealer discards any cards not used in forming the ranking of a pair or better 303. Thus, if for example the dealer's initial hand has a poker ranking of a straight, a flush, a full house, a straight flush, or a royal flush, all five cards are held and no cards are discarded. If the cards in the dealer's initial hand form a ranking of a pair, two pair, three of a kind, or four of a kind, the cards used in forming such ranking are held and the remaining cards are discarded.

If the dealer's initial hand does not have a ranking of a pair or better, the “No” path out of 302 is taken and the hand is examined for a four card flush 304. A four card flush is any four cards in one suit. If the dealer's initial hand contains a four card flush, the “Yes” path out of 304 is taken and the dealer holds the four cards of the same suit and discards the fifth card 305.

If the dealer's initial hand does not have a four card flush, the “No” path out of 304 is taken and the hand is examined for a four card straight 306. A four card straight is any four cards of consecutive rank If the dealer's initial hand contains a four card straight, the “Yes” path out of 306 is taken and the dealer holds the four cards in sequence and discards the fifth card 307.

If the dealer's initial hand does not have a four card straight, the “No” path out of 306 is taken and the hand is examined for any Aces or face cards 308. If the dealer's initial hand contains any Aces or face cards, those cards are held and the remaining cards are discarded 309. If the dealer's hand contains no Aces or face cards, the “No” path out of 308 is taken and the dealer discards all five cards 310.

Note that the predetermined criteria 300 do not allow for any dealer discretion in determining the dealer's discards. For example, if the dealer's initial hand consisted of 5♡ 8♡ 9♡ J♡ J [symbol] , the dealer is compelled to hold the pair of Js and discard the remaining three cards. In this example, the dealer may not instead seek to complete a powerful hand by holding the four card flush and discarding the J [symbol] .

The criteria of FIG. 3 may be summarized by the hierarchy of rules shown in Table 3. The first row of the table that applies to the dealer's initial hand is determined, and any cards making up the description in that row are held while any remaining cards are discarded. If no row of Table 3 applies to the dealer's initial hand, all cards are discarded.

TABLE 3
Dealer criteria for discards

Any pair or better
Any four card flush
Any four card straight
Any Ace or face card

Although the criteria summarized in Table 3 may be used as the basis for allowing the dealer to discard and draw replacement cards, it is only one of many criteria that can be used.

For example, the order of criteria may be changed. The dealer may be required to look for Ace-face cards, then straights, then flushes, then pairs or better. The dealer may also be required to follow only one criteria, such as a pair or better, or else discard.

In other embodiments of the invention, the players and dealer receive an equal number of cards, such as 3, 4, 5 or 6 cards, for example. A predefined criteria is used by the dealer to make discard and draw decisions, while the player can discard and draw using no objective criteria.

In some embodiments of the invention, each player hand is dealt from a separate deck of cards and no communal cards are used to replace discarded cards. It is advantageous to use common cards in a live five-card draw game because fewer cards are needed (less than 52) to replace all player and dealer cards in a five-card game with seven player positions, for example. A total of 45 cards are needed using the common card format. But if no common cards were provided, a total of 80 cards (seven player hands and one dealer hand of five cards each, totally replaced) would be needed, exceeding the number of cards in the deck.

The criteria described above may readily be adapted for use in other embodiments. For example, the relative odds of achieving various hands or the rankings of various hands may generally be different in embodiments having hands consisting of greater than or fewer than five cards. In general, it is desirable that the criteria should be chosen so as to approximately optimize the expected ranking of the dealer's hand after completion of the draw while remaining relatively straightforward to understand and to implement.

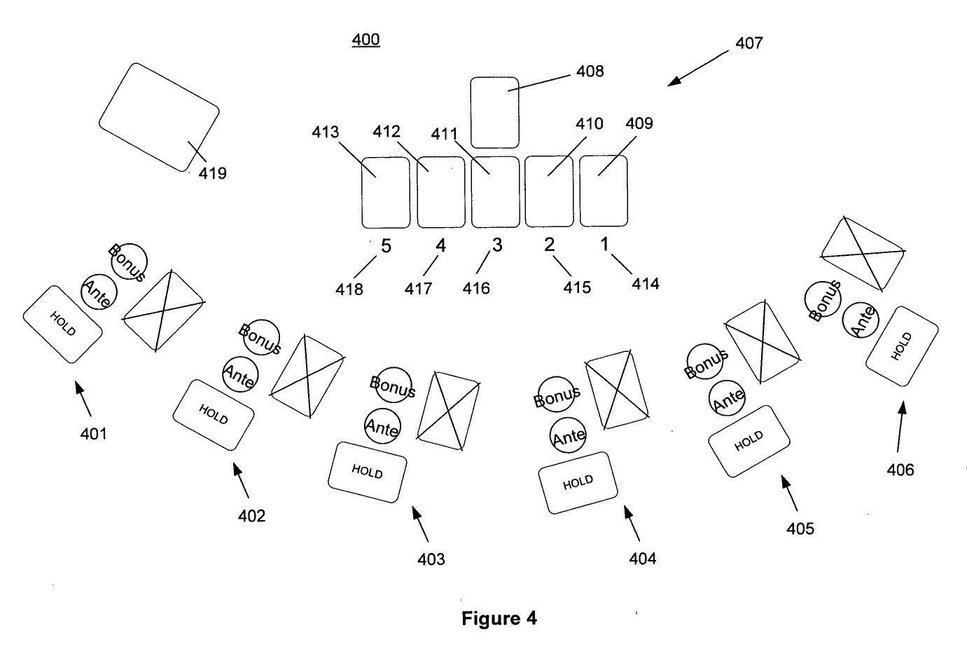

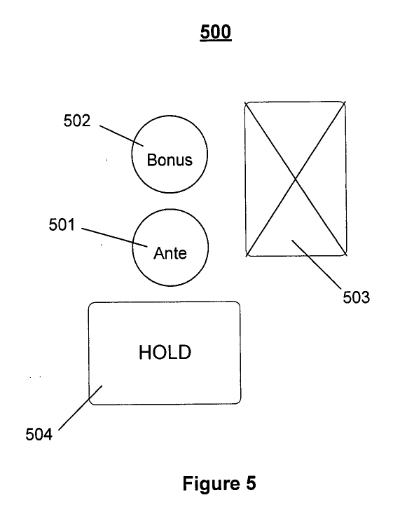

FIG. 4 depicts an example apparatus for use in conjunction with a five card embodiment of a game such as disclosed herein. The surface of a gaming table 400 is shown. The gaming table surface 400 preferably has a felt layout comprising indicia for a plurality of player stations 401-406. An example of a player station for use in an embodiment having a bonus bet is depicted in FIG. 5. The player station 500 comprises indicia of locations for placing an ante wager 501, for placing a bonus wager 502, for placing discarded cards 503, and for placing held cards 504. Referring back to FIG. 4, the surface 400 further comprises a dealer station 407. The dealer station 407 comprises indicia of a location for placing a dealer's initial hand 408 and for placing five community replacement cards 409-413. Each location for a community replacement card has a corresponding indication 414-418 of the position of the corresponding community replacement card in the specified ordering.

A card handling device 419 may be placed on or near the surface of the gaming table 400 or may be integral with the gaming table. For example, the card handling device 419 may be a shuffling machine, for example of the type disclosed in U.S. Pat. No. 6,655,684, U.S. Pat. No. 6,149,154 (both assigned to Shuffle Master, Inc., the disclosures of which are incorporated herein by reference) or any other single deck or multideck shuffling apparatus. The card handling device 419 may include a dealing module for automatically and sequentially dealing cards into hands for play in the disclosed game and also may include a display means for displaying game related information.

Apparatus for use with the game may be embodied in an electronic presentation or in a combination of live and electronic presentation. For example, the disclosed game may be presented on a Table Master™, Vegas Star®, or other interactive gaming system. An example of a suitable gaming platform is disclosed in Publication Application US2005-0164759A1, the disclosure which is hereby incorporated by reference.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the invention. The various appearances “an embodiment,” “one embodiment,” or “some embodiments” are not necessarily all referring to the same embodiments.

If the specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It should be understood that the various techniques described herein may be implemented in logic realized with hardware or software or, where appropriate, with a combination of both. Thus, the methods and apparatus, or certain aspects or portions thereof, may take the form of program code (e.g., instructions) embodied in tangible media, such as floppy diskettes, CD-ROMs, DVDs, hard drives, EPROMS, or any other machine-readable storage medium wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the processes described in connection with the invention, e.g., through the use of an API, reusable controls, or the like. Such programs may be implemented in a high level procedural or object oriented programming language to communicate with a computer system, or may be implemented in assembly or machine language, if desired. In any case, the language may be a compiled or interpreted language, and combined with hardware implementations.

Although exemplary embodiments may refer to using aspects of the invention in the context of one or more stand-alone computer systems, the invention is not so limited, but rather may be implemented in connection with any computing environment, such as a network or distributed computing environment. Still further, aspects of the invention may be implemented in or across a plurality of processing chips or devices, and storage may similarly be effected across a plurality of devices. Such devices might include video gaming devices, personal computers, network servers, handheld devices, supercomputers, or computers integrated into other systems.

While the present disclosure has been described in connection with various embodiments and illustrated in various figures, it is understood that the methods and apparatus described herein may be adapted in a variety of ways. For example, the game may be presented in a live action casino format with a live dealer and real playing cards and chips. Various portions of the live format may be automated or electronically presented. As other examples, the game may be presented on a traditional video gaming apparatus or on a modern multi-player electronic platform. Variations to specific aspects of the game such as, by way of examples and not of limitation, the number of cards in each hand, the wagering structure, the predetermined criteria for dealer discards, the bonus pay table, and the like may be implemented without departing from the teachings or spirit of the present disclosure. For example, a pot wager may be allowed wherein players compete with each other for the best hand. Therefore, the present disclosure should not be limited to any single aspect, but rather construed in breadth and scope in accordance with the appended claims.

What is claimed:

1. A method of playing a wagering game, the method comprising:
accepting an ante wager from at least one player;
dealing a plurality of cards to each player, thereby forming each player's initial hand, and to a dealer, thereby forming the dealer's initial hand;
allowing each player to modify the player's initial hand by discarding at least one card or to continue play with the player's initial hand;
modifying the dealer's initial hand by discarding at least one card or continuing play with the dealer's initial hand, wherein the modifying or continuing play is governed by predetermined criteria;
dealing a plurality of community replacement cards;
forming each player's final hand by replacing cards discarded from each player's initial hand by a corresponding number of community replacement cards in a specified order;
forming the dealer's final hand by replacing cards discarded from the dealer's initial hand by a corresponding number of community replacement cards in a specified order; and
resolving the ante wager according to predetermined game rules.

2. The method as recited in claim 1, wherein the predetermined game rules comprise paying the ante wager if the player's final hand outranks the dealer's final hand according to a predetermined ranking.

3. The method as recited in claim 1, wherein the predetermined game rules comprise paying the ante wager at even money if the player's final hand outranks the dealer's final hand and the dealer's final hand is of at least a predetermined dealer qualifying rank according to a predetermined ranking.

4. The method as recited in claim 3, wherein the predetermined game rules further comprise paying the ante wager at less than even money if the player's final hand outranks the dealer's final hand and the dealer's final hand is not of at least a predetermined dealer qualifying rank according to a predetermined ranking.

5. The method as recited in claim 1, wherein each player's initial hand consists of five cards.

6. The method as recited in claim 1, further comprising accepting a bonus wager from a player, wherein the bonus wager is paid according to a pay table if the player's final hand is of at least a predetermined bonus qualifying rank.

7. The method as recited in claim 1, wherein the predetermined criteria for modifying the dealer's initial hand are to carry out the first applicable rule on the following list:
(1) if the dealer's initial hand has a poker ranking of at least a pair, discard any cards not used in forming the ranking;
(2) if the dealer's initial hand comprises four cards in a first suit, discard the card not in the first suit;
(3) if the dealer's initial hand comprises four cards in numerical sequence, discard the card not in the sequence;
(4) discard any cards having a rank less than a Jack.

8. The method as recited in claim 1, wherein the game is presented, at least in part, electronically.

9. An apparatus for playing a game, the apparatus comprising:
a plurality of player stations, wherein each player station comprises:
indicia of a location for placing an ante wager;
indicia of a location for placing discarded cards; and
indicia of a location for placing held cards;
and a dealer station comprising:
indicia of a location for placing a dealer's initial hand;
indicia of locations for placing a plurality of community draw cards, each said location having corresponding indicia of a position of the corresponding community draw card in a specified order.

10. The apparatus as recited in claim 9, wherein each player station further comprises indicia of a location for placing a bonus wager.

11. The apparatus as recited in claim 9, wherein the user stations and the dealer stations are presented on a playing surface.

12. The apparatus as recited in claim 9, wherein the player stations are presented electronically.

13. The apparatus as recited in claim 13, wherein the dealer station is presented electronically.

14. A computer readable medium comprising computer executable instructions that when executed on a computing device cause the device to:
accept an ante wager from at least one player;
deal a plurality of cards to each player, thereby forming each player's initial hand, and to a dealer, thereby forming the dealer's initial hand;
allow each player to modify the player's initial hand by discarding at least one card or to continue play with the player's initial hand;
modify the dealer's initial hand by discarding at least one card or continuing play with the dealer's initial hand, wherein the modifying or continuing play is governed by predetermined criteria;
deal a plurality of community replacement cards;
form each player's final hand by replacing cards discarded from each player's initial hand by a corresponding number of community replacement cards in a specified order;
form the dealer's final hand by replacing cards discarded from the dealer's initial hand by a corresponding number of community replacement cards in a specified order; and
resolve the ante wager according to predetermined game rules.

15. The computer readable medium as recited in claim 14, wherein the predetermined game rules comprise paying the ante wager if the player's final hand outranks the dealer's final hand according to a predetermined ranking.

16. The computer readable medium as recited in claim 14, wherein the predetermined game rules comprise paying the ante wager at even money if the player's final hand outranks the dealer's final hand and the dealer's final hand is of at least a predetermined dealer qualifying rank according to a predetermined ranking.

17. The computer readable medium as recited in claim 16, wherein the predetermined game rules further comprise paying the ante wager at less than even money if the player's final hand outranks the dealer's final hand and the dealer's final hand is not of at least a predetermined dealer qualifying rank according to a predetermined ranking.

18. The computer readable medium as recited in claim 14, wherein each player's initial hand consists of five cards.

19. The computer readable medium as recited in claim 14, further comprising computer executable instructions that when executed on a computing device cause the device to accept a bonus wager from a player, wherein the bonus wager is paid according to a pay table if the player's final hand is of at least a predetermined bonus qualifying rank.

20. The computer readable medium as recited in claim 14, wherein the predetermined criteria for modifying the dealer's initial hand are to carry out the first applicable rule on the following list:
(1) if the dealer's initial hand has a poker ranking of at least a pair, discard any cards not used in forming the ranking;
(2) if the dealer's initial hand comprises four cards in a first suit, discard the card not in the first suit;
(3) if the dealer's initial hand comprises four cards in numerical sequence, discard the card not in the sequence;
(4) discard any cards having a rank less than a Jack.

21. A method of playing a wagering game, the method comprising:
accepting an ante wager from at least one player;
associating a distinct deck of cards with each player and with a dealer;
dealing a plurality of cards to each player from the deck of cards associated with the player, thereby forming each player's initial hand;
dealing a plurality of cards to the dealer from the deck of cards associated with the dealer, thereby forming the dealer's initial hand;
allowing each player to modify the player's initial hand by discarding at least one card or to continue play with the player's initial hand;
modifying the dealer's initial hand by discarding at least one card or continuing play with the dealer's initial hand, wherein the modifying or continuing play is governed by predetermined criteria;
forming each player's final hand by replacing cards discarded from each player's initial hand by a corresponding number of cards drawn from the deck associated with the player;
forming the dealer's final hand by replacing cards discarded from the dealer's initial hand by a corresponding number of cards drawn from the deck associated with the dealer; and
resolving the ante wager according to predetermined game rules.

22. The method as recited in claim 21, wherein the predetermined game rules comprise:
paying the ante wager at even money if the player's final hand outranks the dealer's final hand and the dealer's final hand is of at least a predetermined dealer qualifying rank according to a predetermined ranking; and
paying the ante wager at less than even money if the player's final hand outranks the dealer's final hand and the dealer's final hand is not of at least a predetermined dealer qualifying rank according to a predetermined ranking.

23. The method as recited in claim 21, further comprising accepting a bonus wager from a player, wherein the bonus wager is paid according to a pay table if the player's final hand is of at least a predetermined bonus qualifying rank.

24. The method as recited in claim 21, wherein the predetermined criteria for modifying the dealer's initial hand are to carry out the first applicable rule on the following list:
(1) if the dealer's initial hand has a poker ranking of at least a pair, discard any cards not used in forming the ranking;
(2) if the dealer's initial hand comprises four cards in a first suit, discard the card not in the first suit;
(3) if the dealer's initial hand comprises four cards in numerical sequence, discard the card not in the sequence;
(4) discard any cards having a rank less than a Jack.

25. The method as recited in claim 21, wherein the game is presented, at least in part, electronically.
